(19) United States
(12) Patent Application Publication
(10) Pub. No.: US 2006/0259250 A1
(43) Pub. Date: Nov. 16, 2006

(54) Extraction of motifs from large scale sequence data

(76) Inventor: Daniel Schwartz, Brookline, MA (US)

Correspondence Address: EDWARDS & ANGELL, LLP, P.O. BOX 55874, BOSTON, MA, 02205, US

(21) Appl. No.: 11/130,310

(22) Filed: May 16, 2005

(51) Int. Cl. G06F 19/00

(52) U.S. Cl. 702/20

(57) ABSTRACT

A method for extraction of statistically significant motifs from large naturally occurring datasets relies upon the intrinsic alignment of the data, extracting motifs through iterative comparison to a dynamic statistical background. In the preferred embodiment, a series of statistical correlations is performed to determine the most significant correlated residues, which in turn are used to identify a motif. The motif is then removed from the dataset and the routine is repeated until no more motifs are found. The motifs are identified in the context of a core residue with respect to a user-selected background, building significant motifs from smaller motifs. In the initial step, the sequence data is justified around a selected core residue. A second matrix that contains a background dataset is then created. The binomial probability of each residue in every column of the data matrix is calculated and the residue-column pair which had the lowest binomial probability below a defined threshold is selected. Those sequences in the background and data matrices that contain that significant residue at the appropriate column are extracted and placed into new matrices. The process is repeated for successive ones of these new matrices until no residue-column pairs with p-values below the threshold are detected. Upon completion, a motif is identified by listing each of the residue-column pairs that have been found to be statistically significant. Next, all sequences from matrices the background and data matrices that contain that motif are removed from those matrices and the process is repeated using the same core residue, completing when no significant residue-column pairs are detected.

### RELATED APPLICATIONS

This application claims priority to U.S. Provisional Application Ser. No. 60/517,400, filed May 14, 2004.

### FIELD OF THE INVENTION

The invention relates to analysis of sequence data and, in particular, to tools for extraction of motifs from biological sequence data.

### BACKGROUND

As the amount of biological sequence data continues to grow exponentially, so does the need for computational tools to analyze such datasets. Most existing methods for motif discovery require that most of the sequences in the starting dataset contain a single motif. Further, they use a static statistical background, or no statistical background, against which motif discovery is carried out. Current tools also generally assume independence of positions in the motif.

As research in molecular biology moves forward, it has become increasingly clear that few cellular processes are unaffected by protein phosphorylation. Protein degradation, localization, and conformation, as well as protein/protein interactions, are only some of the functions in which protein phosphorylation has been implicated. Furthermore, protein phosphorylation levels are central to our current understanding of cell division and signal transduction pathways in both normal and diseased cell state [Schlessinger, J. & Lemmon, M. A. SH2 and PTB domains in tyrosine kinase signaling. Sci STKE 2003, RE12 (2003); Ang, X. L. & Wade Harper, J. SCF-mediated protein degradation and cell cycle control. Oncogene 24, 2860-2870 (2005); Jans, D. A., Xiao, C. Y. & Lam, M. H. Nuclear targeting signal recognition: a key control point in nuclear transport? Bioessays 22, 532-544 (2000)]. Nevertheless, relatively little is known about the majority of protein kinases in the human proteome. Only approximately one tenth of the estimated 500-600 human protein serine, threonine and tyrosine kinases have known consensus sequences for their sites of phosphorylation [Obenauer, J. C., Cantley, L. C. & Yaffe, M. B. Scansite 2.0: Proteome-wide prediction of cell signaling interactions using short sequence motifs. Nucleic Acids Res 31, 3635-3641 (2003)]. Even when consensus sequences are known, in vivo protein substrates are often lacking.

Given the recent exponential increase in identified protein phosphorylation sites by mass spectrometry, a unique opportunity has arisen to understand the motifs which surround such sites. To date, the task of understanding kinase recognition sequences has progressed mainly by a “kinase-driven” approach whereby a kinase of interest is incubated with a combinatorial peptide library and ATP. Edman degradation of the phosphorylated peptides, which have been enriched using a ferric column, leads to the creation of a position weight matrix of the data and hence the consensus sequence [Manning, B. D. & Cantley, L. C. Hitting the target: emerging technologies in the search for kinase substrates. Sci STKE 2002, PE49 (2002)]. Often, such position weight matrices are represented as heat maps. Though visually informative, such heat map representations of sequence data (and position weight matrices in general) can be somewhat deceiving in that they do not show residue correlations or statistical significance. Additionally, despite the fact that the kinase-driven approach has had much success in identifying optimal kinase consensus sequences and substrates, it has suffered from the fact that optimal in vitro binding is often kinetically unfavorable in the cellular environment, thus leading to motifs which are rarely found in the proteome.

What has been needed, therefore, is a motif discovery tool that builds significant motifs from smaller motifs, that determines their significance based on a dynamic rather than a static background, that can extract multiple motifs from the same dataset, and that does not assume independence of positions in the motif.

### SUMMARY

The present invention is a method for extraction of statistically significant motifs from large naturally occurring datasets. The preferred methodology relies upon the intrinsic phospho-residue alignment of biological data, and extracts motifs through iterative comparison to a dynamic statistical background. Results indicate the successful extraction of dozens of novel and known phosphorylation motifs from recently published serine, threonine and tyrosine phosphorylation studies [Beausoleil, S. A. et al. Large-scale characterization of HeLa cell nuclear phosphoproteins. Proc Natl Acad Sci USA 101, 12130-12135 (2004); Rush, J. et al. Immunoaffinity profiling of tyrosine phosphorylation in cancer cells. Nat Biotechnol 23, 94-101 (2005)]. When applied to a linguistic dataset as a test case, the present invention successfully extracted hundreds of English language motifs with a low false positive rate, thus highlighting the versatility of the approach. The present invention not only sheds light on the consensus sequences of identified and yet unidentified kinases and modular protein domains, but may also be used as a tool to understand the potential phosphorylation sites in a protein of interest.

The preferred embodiment of the present invention takes known biologically phosphorylated substrates from unknown kinases and discovers motifs through a “substrate-driven” approach. A series of statistical correlations is performed to determine the most significant correlated residues, which in turn are used to identify a motif. The motif is then removed from the dataset and the routine is performed again until no more motifs are found. The present invention finds motifs in the context of a core residue with respect to a user-selected background, building significant motifs from smaller motifs and determining their significance based on a dynamic, rather than a static, background. The present invention also dynamically “prunes” the starting sequence dataset as significant motifs are found, allowing for maximal coverage of the starting sequence space.

In the initial step, the sequence data is left and right justified around a selected core fixed residue. In the second step, a second matrix that contains the background dataset is created. This matrix is generated in same manner as the experimental data matrix, with the exception that it is derived from “random” sequence data. The width of the background matrix however, is preferably the same as of the data matrix, and ideally it contains an order of magnitude more rows than the data matrix. The selection of the random sequence data to be used depends on the specific application; however, the data is never randomly generated, which would cause independence among the positions of the background matrix and would defeat the purpose of having a dynamic statistical background. Step three is the calculation of the binomial probability of each residue in every column of the data matrix, with the exception of the column containing the fixed residue.

Once binomial probabilities are calculated, step four is the selection of the residue-column pair which had the lowest binomial probability below a defined threshold. Those sequences in the background and data matrices that contain that significant residue at the appropriate column are extracted and placed into new matrices. Step five is carried out through the repetition of steps three and four on successive ones of these new matrices until no residue-column pairs with p-values below the threshold are detected. Upon completion of step five, a motif is identified by listing each of the residue-column pairs that have been found to be statistically significant. In step six, all sequences from matrices the background and data matrices that contain the motif extracted at the end of step five are removed from those matrices. The process is then repeated using the same core residue, starting at step three, completing when no significant residue-column pairs are detected at step three. The entire process is then repeated for the additional possible core residues.

### BRIEF DESCRIPTION OF THE DRAWINGS

FIG. 1 is a flow chart of a preferred embodiment of the method of the invention;

FIGS. 2a-2d depict an example application of the present invention;

FIG. 3 is a functional block diagram of the significant modules of a software implementation of an embodiment of the present invention;

FIG. 4 is a conceptual representation of an experimental embodiment of the present invention; and

FIG. 5 is a conceptual representation of the results of an example application of the embodiment of FIG. 4.

### DETAILED DESCRIPTION

The present invention takes a large dataset, such as DNA or protein sequences, and identifies statistically significant motifs. A preferred embodiment takes known biologically phosphorylated substrates from unknown kinases and discovers motifs through a “substrate-driven” approach. A series of statistical correlations is performed to determine the most significant correlated residues, which in turn are used to identify a motif. The motif is then removed from the dataset and the routine is performed again until no more motifs are found. Results using various biological datasets indicate that the invention returns motifs in the literature as well as novel motifs.

The present invention finds motifs in the context of a core character with respect to a user-selected background. The present invention differs from current motif discovery tools in that it builds significant motifs from smaller motifs and determines their significance based on a dynamic, rather than a static, background. The present invention also dynamically “prunes” the starting sequence dataset as significant motifs are found, allowing for maximal coverage of the starting sequence space.

In the initial step of the present invention, the sequence data is left and right justified around a selected core fixed character. Thus, at the end of this step, each sequence in the dataset is of equal width and the residue of interest is located at the same position in each sequence. The sequences derived for this step can overlap each other, i.e. a specific character may be part of more than one sequence in the justified sequence dataset. A matrix representation of the justified data is then created. In this sequence dataset matrix, where m equals the number of sequences in the dataset and n equals the width of each sequence, then the relevant sequence data is placed into an m-by-n matrix, D, such that there exists a user-specified character, X, which is located at position jₓ in each row of D.

In the second step of the invention, a second matrix, B, which contains the background dataset is created. This matrix is generated in same manner as matrix D, with the exception that it is derived from “random” sequence data (i.e., data which is not centered on a specific character). The width of matrix B however, is preferably the same as matrix D, and ideally it contains an order of magnitude more rows than matrix D. The selection of the random sequence data to be used depends on the specific application; however, the data is never randomly generated, which would cause independence among the positions of the background matrix and would defeat the purpose of having a dynamic statistical background. For example, when serine phosphorylation data generated by tandem mass spectrometry was analyzed in one test, tandem mass spectrometry-generated peptides centered at non-phosphorylated serine residues were used to create the background matrix. This was done to keep the background consistent, as it is generally preferable to keep the background dataset as similar to the motif dataset as possible in order to avoid biases and to enable extraction of the more subtle motifs. In most cases, the background dataset matrix is not centered on the same character as the sequence dataset matrix.

Step three of the invention involves the calculation of the binomial probability of each character in every column of D, with the exception of the column containing the fixed character. To compute these binomial probabilities, three pieces of information are needed: i) the fractional percentage of each character in every column of the background matrix, B; ii) a frequency tabulation of each character in every column of the data matrix, D; and iii) the number of rows in matrix D. The cumulative distribution function (CDF) of the binomial formula yields the binomial probability for each character,

$$P ( m , {f}_{Xj} , {p}_{Xj} ) = {\sum }_{i = {f}_{Xj}}^{m} ( \begin{matrix}m \\ i\end{matrix} ) {{p}_{Xj}^{i} ( 1 - {p}_{Xj} )}^{m - i}$$

where m equals the number of rows in D, fₓⱼ equals the frequency of character X in column j of D, and pₓⱼ equals the fractional percentage of character X in column j of B.

Once binomial probabilities are calculated, step four of the invention involves the selection of the character-column pair which had the lowest binomial probability below a defined threshold (typically p<0.000001). Those sequences in D and B that contain that significant character at the appropriate column are extracted and placed into new matrices, denoted D′ and B′ respectively. Although currently preferred software embodiment of the present invention does not exclude any columns through the iterations of steps 3 and 4, it being unnecessary because the “fixed” columns only contain a single character in both the dataset and background matrices and thus can never be selected as “significant” again, they may be excluded and the invention will work in exactly the same manner.

Step five of the invention is carried out through the repetition of steps three and four on successive new matrices D′ and B′ until no character-column pairs with p-values below the threshold are detected. Upon completion of step five, a motif is identified by listing each of the character-column pairs that have been found to be statistically significant.

To illustrate this, suppose there is a potential motif of width 7 centered around the fixed residue serine (S). Before the method is employed, the motif is as follows:
XXXSXXX
where X denotes any residue. In this example, following steps three and four, P5 (proline at column 5) is found to be the most significant residue-column combination. The partially-identified motif can then be written as follows:
XXXSPXX

Step five of the invention, iteration over steps three and four, is then performed and residue-column combinations Y2, L1, and P7 are found to be most statistically significant. The fully-identified motif is then written as:
LYXSPXP
(leucine-tyrosine-any-serine-proline-any-proline)

In step six of the invention, all sequences from matrices D and B that contain the motif extracted at the end of step five are removed from these matrices. The process is then repeated using the same core character, starting at step three. The process completes when no significant character-column pairs are detected at step three.

The process is then repeated for the additional possible core characters. For example, in order to get a comprehensive view of all the motifs present in the yeast proteome, the analysis is performed 20 times, once for each possible residue as the core.

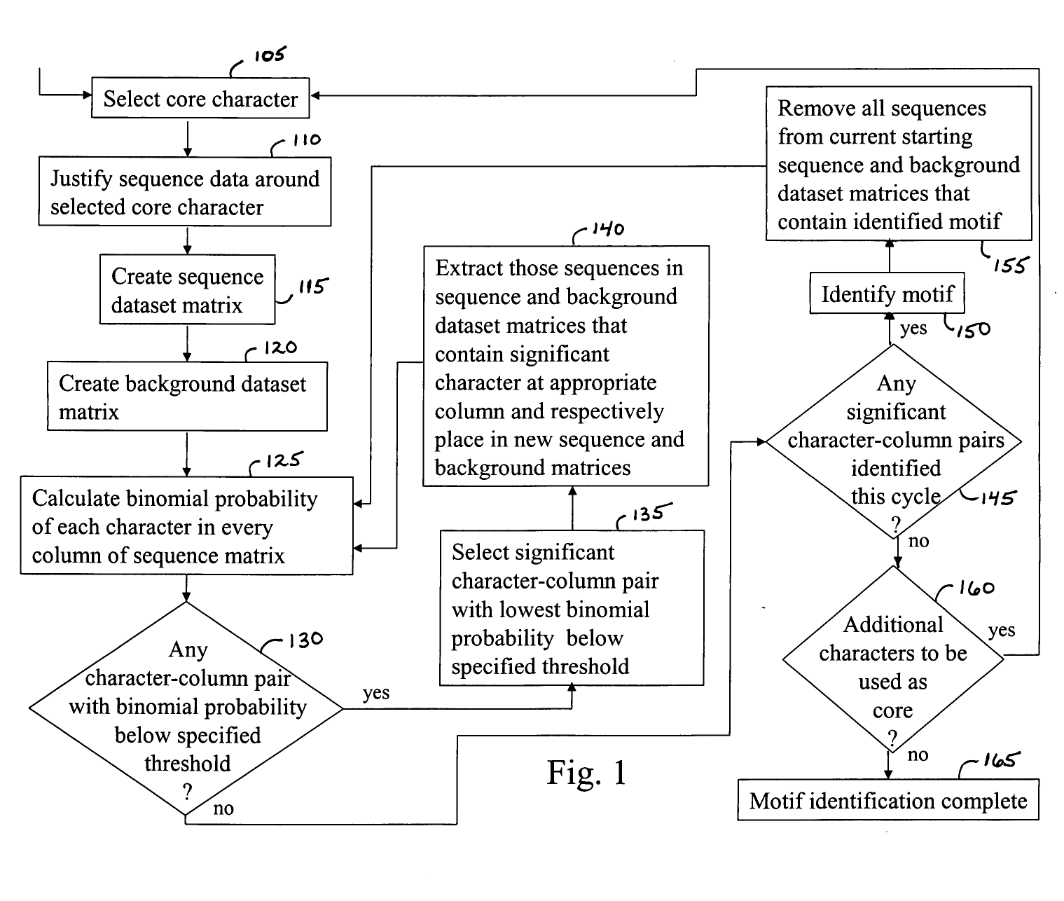

FIG. 1 is a flow chart of a preferred embodiment of the method of the invention. As shown in FIG. 1, a residue is selected 105 to be the initial core character for the sequence dataset. The sequence data is then right and left justified 110 around the selected core character. The justified data is used to create 115 the sequence dataset matrix. A background dataset matrix is then created 120. Using the two matrices, the binomial probability of each possible character in every column of the sequence dataset matrix is then calculated 125.

The binomial probabilities calculated are compared to a specified threshold 130 and, if one or more are below the threshold, then the character-column pair having the lowest binomial probability under the threshold is selected 135. The threshold may be user-specified, predefined, or automatically selected. Those sequences in the sequence and background dataset matrices that contain the selected character-column pair are then extracted 140 and placed into new sequence and background dataset matrices, and the binomial probability of each character in every column of the new sequence dataset matrix is calculated 125.

When no character-column pair has a binomial probability below the specified threshold 130, but at least one significant character-column pair has been identified during the current cycle 145, the present motif is identified 150 and all sequences containing the identified motif are removed 155 from the current initial sequence and background dataset matrices. Using these two new initial sequence and background dataset matrices, the process begins again with the calculation 125 of the binomial probability of each character in every column of the new initial sequence dataset matrix.

If no significant character-column pair has been identified during the current cycle 145, but there are additional characters available to be used as the core residue, a new core character is selected 105 and the cycle is repeated. Otherwise, the motif identification process is complete 165.

While the preferred embodiment of FIG. 1 uses binomial probabilities as the basis for assessing the statistical significance of the characters, any suitable statistical test known in the art may be advantageously employed in the present invention. In the more general case, steps 125, 130, 135 are replaced and/or augmented by steps that are appropriate to the particular statistical methodology being employed.

In one embodiment, the method of the present invention was used to find motifs within a phosphorylation dataset. Potential motifs included kinase phosphorylation and phospho-peptide ligand motifs. In this embodiment, a “phospho-specific” implementation was used to take advantage of the intrinsic alignment of the data in the dataset around a phospho-residue. The data used was justified on the ends and centered at the phosphorylation site. The list of m data strings of length n was used to create an m by n matrix. The background dataset used for statistical comparisons was comprised of protein database and mass-spectrometry generated peptides centered on either serine (S), threonine (T), or tyrosine (Y), depending on the phosphorylation analysis. The peptides may or may not have been phosphorylated and represented a good background. The most over-represented residue in the dataset based on comparison to the background set was then identified and the binomial distribution was used to determine the probability of observing f or more successes in m trials, given a probability of success p.

One of the motifs identified through this experiment was [RK]xxtPP, which is found in a wide range of protein types. Use of the present invention to identify motifs within a phosphorylation dataset allows the researcher to profile data, including gaining an understanding of the kinases acting in a given sample and the types of proteins being phosphorylated, to discover novel kinase motifs, to discover potential phospho-peptide ligands involved in peptide-protein interactions, leading to novel modular domains. Additionally, the present invention is likely to allow the researcher to do a much better job at such things as phospho-site prediction than currently-available tools.

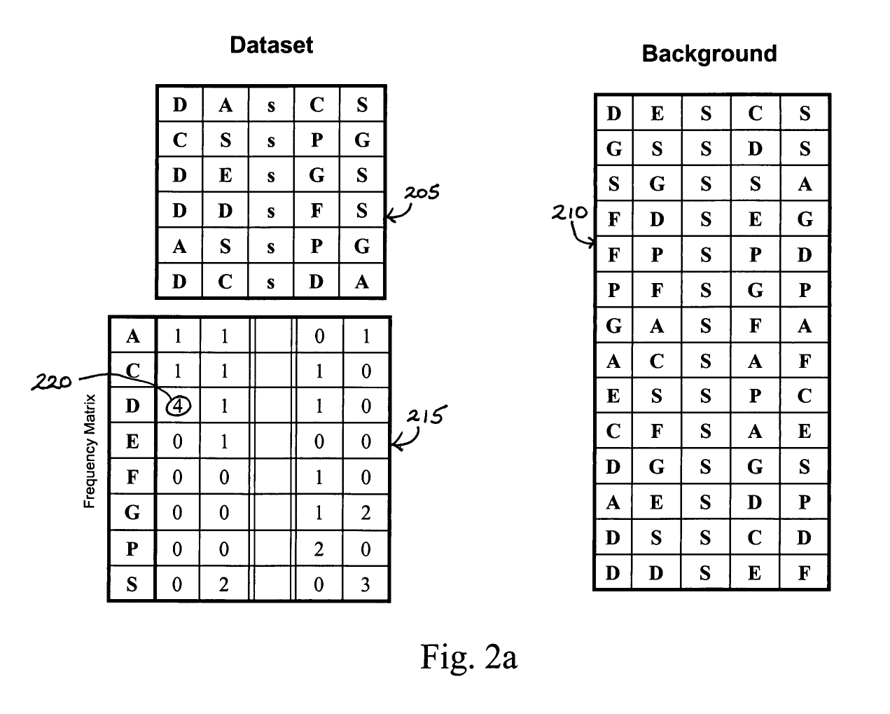

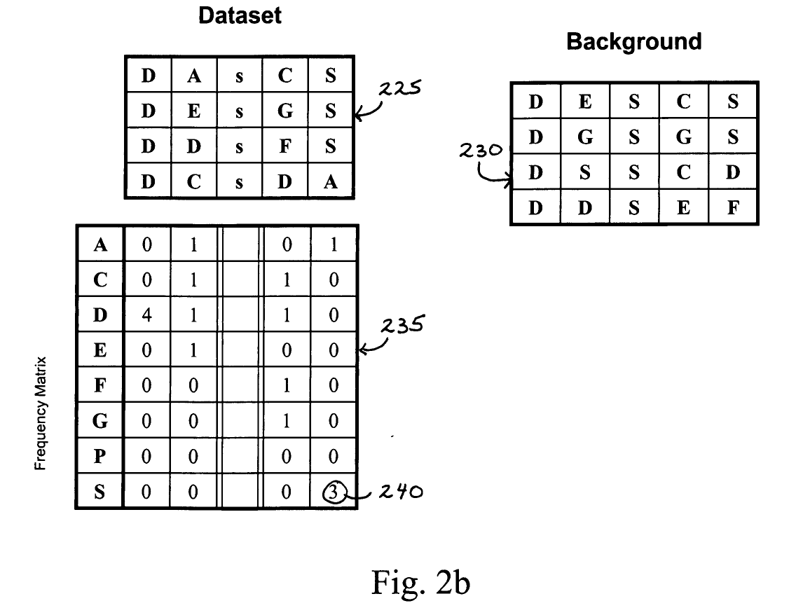

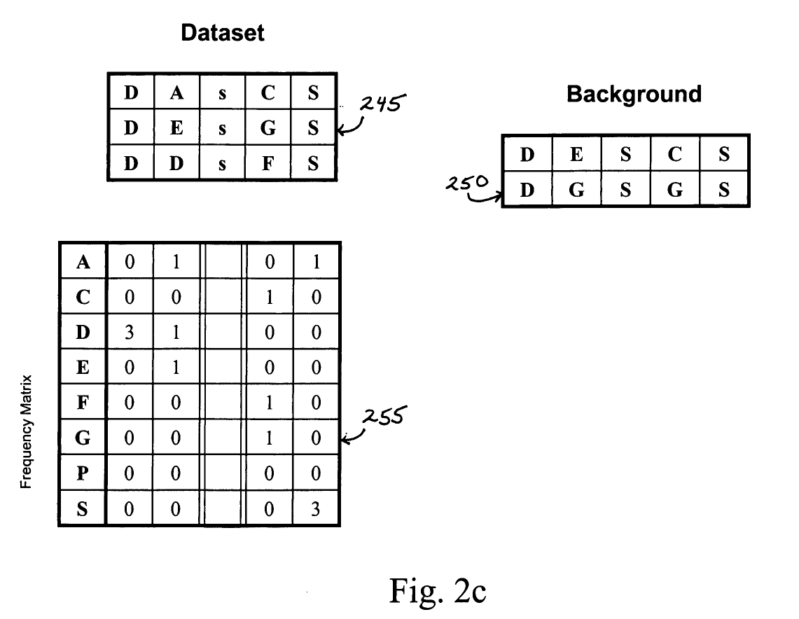

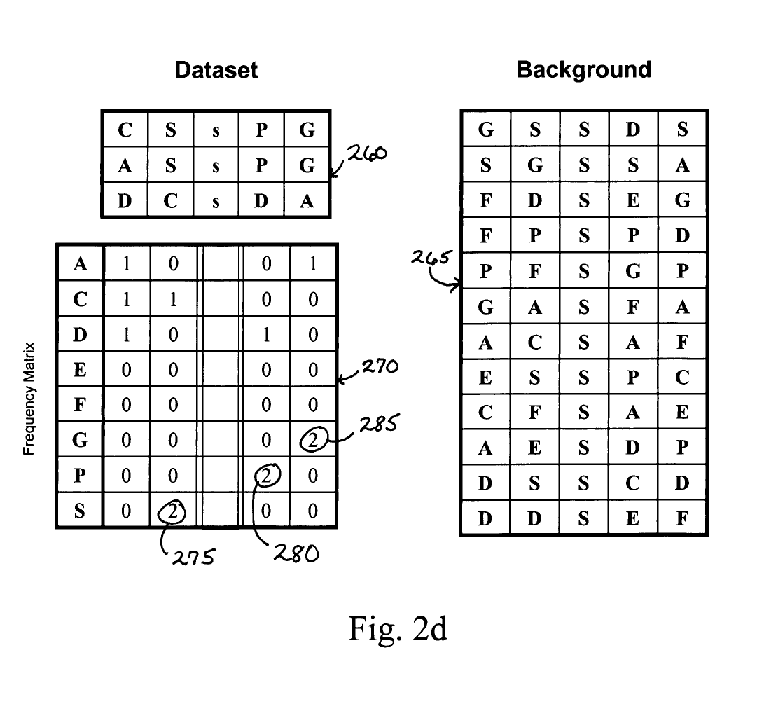

FIGS. 2a-2d depict the steps in a simplified version of this example application of the present invention. As shown in FIG. 2a, initial sequence dataset matrix 205 contains 5-position sequences centered around phosphorylated serine residues (s) and initial background dataset matrix 210 contains 5-position sequences centered around non-phosphorylated serine residues (S). The binomial probabilities for each residue-position pair in the sequence dataset are calculated based on the frequencies with which they are observed in the background matrix and are displayed in frequency matrix 215. In the example shown, the most significant residue-position pair 220, i.e. the pair with the lowest p-value, is D1 (D at position 1) and is selected. At this point, the motif has been partially identified as Dxsxx. All other sequences are then removed from the dataset and background matrices.

In FIG. 2b, the resulting new sequence dataset matrix 225 and new background dataset matrix 230 are shown. Only those sequences that are Dxsxx were kept. The binomial probabilities for each residue-position pair are calculated based on the frequencies with which they are observed in the new background matrix and are displayed in new frequency matrix 235. The most significant residue-position pair, i.e. the pair with the lowest p-value, is S5 (serine at position 5) and is selected 240. At this point, the current motif has been partially identified as DxsxS. All other sequences are then removed from the dataset and background matrices.

In FIG. 2c, the resulting new sequence dataset matrix 245 and new background dataset matrix 250 are shown. Only those sequences that are DxsxS were kept. The binomial probabilities for each residue-position pair are calculated based on the frequencies with which they are observed in the new background matrix and are displayed in new frequency matrix 255. Since no residue-position pairs are found to be significant at this point, the step is finished and the current motif is identified as DxsxS. In practice, the actual background set is much larger than shown, so accurate probabilities may be computed at this stage.

In FIG. 2d, the step 4 set reduction takes place. All sequences containing the previously identified motif (DxsxS) are removed from the test dataset and background matrices, producing new initial sequence dataset matrix 260 and new initial background dataset matrix 265. The steps are reiterated, producing successive new frequency matrices 270 until a new motif, xSsPG, is identified from significant residue-column pairs S2 (serine at position 2) 275, P4 (proline at position 4) 280, and G5 (glycine at position 5) 285.

While the present invention treats all residues at a given position as a single residue, motifs and sequence data having degenerate positions with more than one residue present can also be identified and/or included in the dataset. One mechanism for achieving this uses a degenerate amino acid code. In this alternative, each degenerate dataset and background matrix position is translated into a single letter representation. For example, it can be specified that A=AG, D=DE, F=FY, K=KR, I=ILMV, Q=QN, and S=ST. The degenerate residues are then substituted back into the representation of any identified motifs containing them. For example, in this scenario, an identified motif of Dxsxx becomes [DE]xsxx.

When no additional significant residue-position pairs are detected following step 4, i.e. the dataset and background matrices “look the same” because they have the same residue probabilities, the cycle is complete. The motifs identified at the end of each iteration of step 3 are tallied. In the example presented in FIGS. 2a-2d, the identified motifs are DxsxS and xSsPG. The full process is then repeated for all the other possible core residues in order to fully analyze the starting sequence dataset.

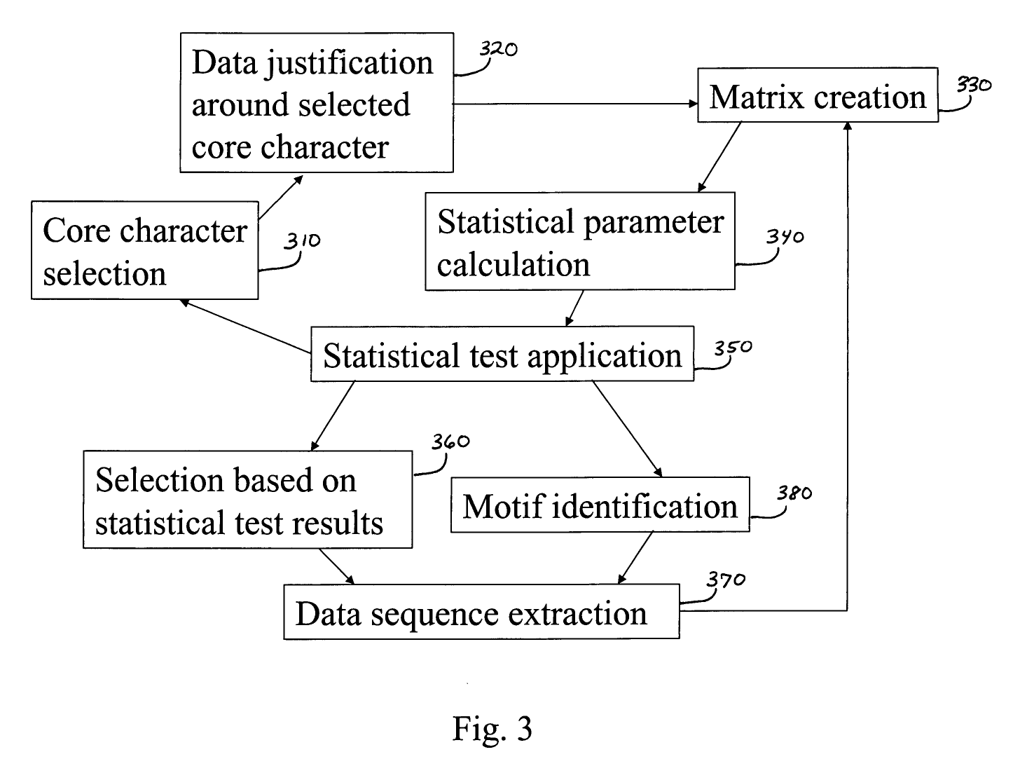

A preferred embodiment of the present invention is implemented in software using any suitable language known in the art. For example, one embodiment has recently been implemented using Perl. FIG. 3 is a functional block diagram of an example software implementation of an embodiment of the present invention. In FIG. 3, core character selection function 310 may either accept character selections from the user or automatically select a core character from the sequence dataset. Data justification function 320 justifies sequence data around the selected core character at the desired sequence length. Data justification function 320 may also be employed to justify background data at the same sequence length, or a separate function may be employed.

Matrix creation function 330 creates the sequence and background dataset matrices that are then used by statistical parameter calculation function 340 to provide statistically-based parameters to statistical test application 350. In the preferred embodiment, statistical parameter calculation function 340 is a binomial probability calculation function that provides binomial probability data to statistical test application 350, which is a binomial probability comparator that compares the binomial probability data to a defined threshold. Selection function 360 then selects a character-column pair based on the results of the chosen statistical test, the sequences containing that character-column pair are extracted from sequence and background datasets by data sequence extraction function 370, and the extracted sequences are passed back to matrix creation function 330 for creation of modified sequence and background dataset matrices. In the preferred embodiment, selection function 360 is a binomial probability selection function that selects the character-column pair having the most significant binomial probability below the threshold.

When statistical test application 350 identifies no character-column pairs with significant statistical parameters, motif identification function 380 identifies the current motif. Data sequence extraction function 370 then extracts all sequences having that motif from the sequence and background datasets and new initial sequence and background dataset matrices are created by matrix creation function 330. The process then returns to binomial probability calculation function 340 and reiterates until no new motifs are found for the selected core character, after which it may return to core character selection function 310 to repeat with a different core character.

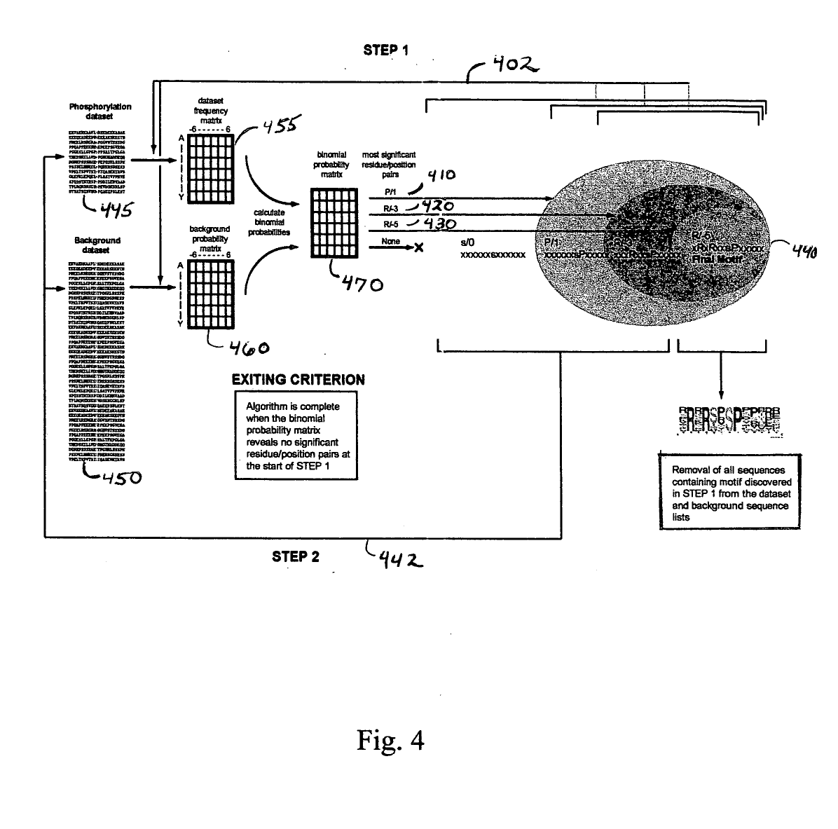

A conceptual representation of an experimental embodiment of the motif extraction method of the present invention is shown in FIG. 4. As conceptually represented in FIG. 4, the motif building strategy is divided into two major steps. In step 1 402, the motif is built through a recursive search of the sequence space, with each iteration yielding the most significant residue/position pair until no more significant pairs can be detected. This is shown in FIG. 4 by P/1 410, R/-3 420, and R/-5 430, thus making the first motif 440 RxRxxsP (where “x” denotes any residue, and lowercase letters denote phosphorylated residues). Set reduction occurs in step 2 442, wherein all the sequences containing the motif are removed from both the phosphorylation 445 and background 450 datasets. The motif logo is created from just the sequences removed from the phosphorylation dataset 445 following step 1 402. Although FIG. 4 depicts only one iteration of the method, it is the sequential iteration of steps 1 402 and that ultimately leads to the final list of motifs.

The method commences with the establishment of two parallel sequence datasets: the phosphorylated peptide dataset 445 from which motifs will be built, and a peptide dataset 450 used for background probability calculations. Next, the two datasets are converted into position weight matrices 455, 460 of equal dimensions, wherein each matrix contains information on the frequency of all residues at the six positions upstream and downstream of the phosphorylation site. Using the information encoded in these two matrices 455, 460, a third matrix 470, the binomial probability matrix, is created. Specifically, this matrix 470 contains the probability of observing s or more occurrences of residue x at position j (taken from the phosphorylation matrix 455), given a background probability p for residue x at position j (taken from the background matrix 460).

The motif building step of the method is a greedy recursive search of the sequence space to identify highly correlated residue/position pairs with the lowest p-values. Each recursive iteration identifies the most statistically significant residue/position pair meeting a user-defined binomial probability threshold (in this study taken as p<10⁻⁶) and occurrence threshold (which represents the minimal number of sequences in the phosphorylation dataset needed to match the residue/position pair). When such a pair is found, the sequence space of the phosphorylation 455 and background 460 matrices are reduced by retaining only those sequences containing the selected residue/position pair, and a new binomial probability matrix 470 is calculated. This recursive pruning procedure is repeated until no more statistically significant residue/position pairs which meet the occurrence threshold are detected. At this point, the motif 440 is identified by the tally of residue/position pairs selected during this step.

The next major step of the method involves set reduction of the phosphorylation 445 and background 450 datasets by removing all of those sequences which match the motif 440 identified in the motif building step. The purpose of this step is to remove the effects of those peptides with identified motifs from confounding the search for other significant motifs. Thus, performing the sequential loop of motif building followed by set reduction results in a decomposition of the phosphorylation sequence database into a list of significant motifs. The method is complete (i.e., the loop exits) when the motif building step fails to identify any significant residue/position pairs.

Whereas most methods of motif discovery require that most of the sequences in the starting dataset contain a single motif, the present invention has no such requirements. In fact, the invention is designed to deconvolute the data and extract multiple motifs (or no motifs) from the same dataset. Few other methods use this “set reduction” approach. The concept of pre-aligning the data on a specific residue also has not previously been used in motif discovery. Although it presupposes that there will exist a residue in the motif that is highly significant, this is a warranted assumption given the biological literature (i.e., motifs almost always have a central core).

In the present invention, the background matrix (B) continuously gets modified with the dataset matrix (D). The statistical background is therefore constantly evolving. The use of a dynamic statistical background on which motifs are discovered has not been used in such a way previously. In fact, some methods do not even use a statistical background at all. Thus, the method does not assume independence of positions in the motif, which tends to be a weakness of most other approaches.

One use of the present invention is for discovery of protein motifs. Such motifs may be involved in, but are not limited to, protein localization, protein/protein interactions, protein structure, and protein modifications (e.g. phosphorylation, ubiquitination, etc.). Another use is discovery of DNA/RNA motifs. When applied to DNA, the method will typically detect protein binding sequences (e.g. promoter binding sites). In the case of RNA, the invention may be used to deduce secondary structures (e.g. hairpin loops). Other uses include rapid alignment of large sequence datasets, deduction of evolutionary relationships between organisms based on their motif composition, and identification of peptide-based inhibitors. In the case of a peptide motif that is known to act as a ligand for peptide/protein interaction, such a motif may be tested as an inhibitor.

In the past, the low number of localized phosphorylation sites cited in the literature made substrate-driven approaches to determining kinase consensus motifs difficult. However, refinements of several affinity-based strategies such as immunoaffinity [Rush, J. et al. Immunoaffinity profiling of tyrosine phosphorylation in cancer cells. Nat Biotechnol 23, 94-101 (2005)], immobilized metal affinity chromatography (IMAC) [Ficarro, S. B. et al. Phosphoproteome analysis by mass spectrometry and its application to Saccharomyces cerevisiae. Nat Biotechnol 20, 301-305 (2002)], and strong cation exchange (SCX) chromatography [Beausoleil, S. A. et al. Large-scale characterization of HeLa cell nuclear phosphoproteins. Proc Natl Acad Sci USA 101, 12130-12135 (2004)], coupled with the enabling technology of tandem mass spectrometry have more than doubled the number of phosphorylation sites in the past year alone, with several studies reporting from several hundred to several thousand sites [Beausoleil, S. A. et al. Large-scale characterization of HeLa cell nuclear phosphoproteins. Proc Natl Acad Sci USA 101, 12130-12135 (2004); Rush, J. et al. Immunoaffinity profiling of tyrosine phosphorylation in cancer cells. Nat Biotechnol 23, 94-101 (2005); Collins, M. O. et al. Proteomic analysis of in vivo phosphorylated synaptic proteins. J Biol Chem 280, 5972-5982 (2005); Ballif, B. A., Villen, J., Beausoleil, S. A., Schwartz, D. & Gygi, S. P. Phosphoproteomic analysis of the developing mouse brain. Mol Cell Proteomics 3, 1093-1101 (2004); Gruhler, A. et al. Quantitative phosphoproteomics applied to the yeast pheromone signaling pathway. Mol Cell Proteomics 4, 310-327 (2005); Nuhse, T. S., Stensballe, A., Jensen, O. N. & Peck, S. C. Phosphoproteomics of the Arabidopsis plasma membrane and a new phosphorylation site database. Plant Cell 16, 2394-2405 (2004); Loyet, K. M., Stults, J. T. & Arnott, D. Mass spectrometric contributions to the practice of phosphorylation site mapping through 2003: a literature review. Mol Cell Proteomics 4, 235-245 (2005)].

Two of these recently published large-scale mass spectrometry studies were chosen as test sets for the present invention. The first of these employed SCX for the enrichment of phosphopeptides from HeLa cell nuclei, resulting in the elucidation of 1594 unique phosphoserine and 195 unique phosphothreonine sites [Beausoleil, S. A. et al. Large-scale characterization of HeLa cell nuclear phosphoproteins. Proc Natl Acad Sci USA 101, 12130-12135 (2004)]. The second study used an anti-phosphotyrosine antibody to enrich for phosphorylated tyrosine residues in pervanadate treated Jurkat cells (151 sites), cells expressing constitutively active NPM-ALK fusion kinase (237 sites), and cells expressing constitutively active Src kinase (185 sites) [Rush, J. et al. Immunoaffinity profiling of tyrosine phosphorylation in cancer cells. Nat Biotechnol 23, 94-101 (2005)].

The Beausoleil, Jedrychowski, et al. phosphoserine and phosphothreonine dataset and the Rush, et al. phosphotyrosine datasets were used as starting points for the analysis. Only those tryptic peptides where the exact site of phosphorylation was known were selected. Peptides were mapped back to their prospective proteins and six residues upstream and downstream of the phosphorylation sites were re-extracted from the proteome sequence. This step removed the non-uniformity of tryptic peptide fragments to produce a dataset of known phosphorylation sites in a uniform 13 residue context. In cases where the phosphorylation site was within six residues of a protein terminus, the sequence was discarded. Thus, only those sites which had sequence information for 12 residues surrounding the phosphorylation site were used. The sequences were then filtered for redundancy, so that only unique sequences remained. This formatting procedure gave rise to 1594 phosphoserine centered sequences, 195 phosphothreonine centered sequences, and 573 phosphotyrosine centered sequences.

This analysis was dependent upon the ability to compare the distribution of residue frequencies in the phosphorylation dataset with a background model. Background datasets were created in two ways. For the phosphoserine and phosphothreonine analyses, background datasets were created using fully-tryptic peptides generated from mass spectrometry data and searched using the human protein database with high Sequest [Yates, J. R., 3rd, Eng, J. K. & McCormack, A. L. Mining genomes: correlating tandem mass spectra of modified and unmodified peptides to sequences in nucleotide databases. Anal Chem 67, 3202-3210 (1995)] thresholds (Xcorr>2.5, dCn>0.1). Data was centered on non-phosphorylated serine or threonine residues and formatted according to the same procedure described in the previous section, thus yielding two similarly aligned background datasets containing 27,980 sequences centered on serine and 20,208 sequences centered on threonine. Due to the lower abundance of tyrosine residues, the background dataset for the phosphotyrosine analysis was created by taking six residues upstream and downstream of every tyrosine residue in the human proteome. This resulted in a background dataset centered on tyrosine containing 441,343 sequences. It should be noted however, that despite the intention of using a mass spectrometry-based background to avoid mass spectrometry-specific residue biases, performing the serine and threonine analyses with a proteomic background as opposed to a mass spectrometry-based background did not significantly alter the motifs extracted.

To allow for conservative amino acid substitutions at various positions, the phosphorylated peptide and background lists were condensed from a 20 amino acid code to a degenerate 11 amino acid code based on chemical properties as follows: A=AG, D=DE, F=FY, K=KR, I=ILMV, Q=QN, S=ST, C=C, H=H, P=P, W=W. The analysis was then carried out as described for the non-degenerate analysis.

The motif building strategy was carried out by finding successive significant residue/position pairs. Though the significance threshold is a parameter of the algorithm, for all analyses in this paper, residue/position pairs were deemed significant if they had random probabilities less than 10⁻⁶ according to a binomially distributed model,

$$P ( m , {f}_{Xj} , {p}_{Xj} ) = {\sum }_{i = {f}_{Xj}}^{m} ( \begin{matrix}m \\ i\end{matrix} ) {{p}_{Xj}^{i} ( 1 - {p}_{Xj} )}^{m - i} ,$$

where m equaled the number of sequences in the dataset matrix, fₓⱼ equaled the frequency of residue x at position j in the dataset matrix, and pₓⱼ equaled the fractional percentage of residue x at position j in the background matrix. The result was calculated using the pbinom function in the Math::CDF PERL module. The function could not calculate probabilities below 10⁻⁶. Since each recursive iteration of the algorithm chose the residue/position pair with the lowest binomial probability, if more than one pair had probabilities of 10⁻¹⁶, then the pair with the greater frequency in the dataset matrix was selected. Despite the statistical significance of every motif extracted, heuristic scores for the motifs were calculated as the sum of the negative log of the binomial probabilities used to generate the motifs using the equation

$$Score ( motif ) = \sum - log ( {p}_{binomial} ) .$$

Table 1 depicts the results of the application of the present invention to the set of threonine phosphorylated peptides from the Beausoleil, Jedrychowski, et al. dataset, showing normal and degenerate analyses of phosphorylated threonine and serine motifs.

TABLE 1

| | | | | |
|---|---|---|---|---|
| | | | Phospho Dataset | Background Dataset |
| Motif | Literature | Score* | (Matches/Size) | (Matches/Size) |

Threonine Motifs**

| | | | | | | |
|---|---|---|---|---|---|---|
| ......tPP.... | Novel | 32.00 | 62 | 195 | 142 | 20208 |
| ......tP..... | Proline- | 16.00 | 79 | 133 | 1424 | 20066 |
| | directed | | | | | |
| ...[KR]..tPP.... | Novel | 41.12 | 26 | 195 | 16 | 20208 |
| ......tPP.... | Novel | 28.11 | 36 | 169 | 126 | 20192 |
| ...[KR]..tP....[KR] | Novel | 35.18 | 10 | 133 | 2 | 20066 |
| ......tP..... | Proline- | 16.00 | 69 | 123 | 1422 | 20064 |
| | directed | | | | | |
| Serine Motifs*** | | | | | | |
| .R.R..sP..... | Novel | 48.00 | 34 | 1594 | 2 | 27980 |
| ...R..sP.P... | Novel | 38.04 | 36 | 1560 | 12 | 27978 |
| ......sP...RR | Novel | 39.24 | 25 | 1524 | 7 | 27966 |
| ...R..sP..... | Novel | 28.07 | 70 | 1499 | 69 | 27959 |
| ....P.sP..... | MAPK | 28.23 | 169 | 1429 | 265 | 27890 |
| ......sP.R... | CDK | 29.48 | 69 | 1260 | 75 | 27625 |
| ......sPP.... | Novel | 24.87 | 79 | 1191 | 127 | 27550 |
| ......sP.K... | CDK | 24.54 | 57 | 1112 | 87 | 27423 |
| ..R...sP..... | Novel | 23.21 | 40 | 1055 | 60 | 27336 |
| ......sP..... | Pro- | 16.00 | 359 | 1015 | 1490 | 27276 |
| | directed | | | | | |
| ......sD.E... | CK II | 32.00 | 95 | 656 | 208 | 25786 |
| ......sE.E... | CK II | 32.00 | 68 | 561 | 273 | 25578 |
| .R.RS.s...... | AKT | 41.31 | 22 | 493 | 10 | 25305 |
| ...RS.s...... | AKT | 25.21 | 29 | 471 | 93 | 25295 |
| ...R..s...... | CaMK II | 16.00 | 63 | 442 | 1043 | 25202 |
| .....DsD..... | CK II- | 24.58 | 25 | 379 | 125 | 24159 |
| | like | | | | | |
| ......s.D.... | CaMK II | 9.69 | 55 | 354 | 1459 | 24034 |
| ......s.E.... | G-CK | 10.44 | 60 | 299 | 1802 | 22575 |
| .[KR].[KR]..sP....[KR] | Novel | 64.00 | 20 | 1594 | 0 | 27980 |
| .[KR][ST].sP...[KR]. | Novel | 56.68 | 26 | 1574 | 1 | 27980 |
| ...[KR]..sP.P... | Novel | 41.84 | 47 | 1548 | 20 | 27979 |
| ......sP.[KR]... | CDK | 31.95 | 157 | 1501 | 203 | 27959 |
| ....P.sP..... | MAPK | 30.52 | 158 | 1344 | 240 | 27756 |
| ......sP...[KR][KR] | Novel | 39.61 | 38 | 1186 | 20 | 27516 |
| ...[KR]..sP..... | Novel | 26.93 | 81 | 1148 | 126 | 27496 |
| ......sPP.... | Novel | 23.48 | 62 | 1067 | 114 | 27370 |
| ......sP..... | Proline- | 16.00 | 349 | 1005 | 1470 | 27256 |
| | directed | | | | | |
| ......s[DE].[DE].[DE]. | CK II | 44.15 | 107 | 656 | 218 | 25786 |
| .....[DE]s[DE].[DE]... | CK II | 39.00 | 44 | 549 | 115 | 25568 |
| ......s[DE][DE][DE]... | CK II | 33.83 | 29 | 505 | 106 | 25453 |
| .[KR].[KR][ST].s...... | AKT | 38.33 | 29 | 476 | 57 | 25347 |
| ......s.[DE].[DE].. | CK II- | 22.35 | 44 | 447 | 548 | 25290 |
| | like | | | | | |
| ...[KR][ST].s...... | AKT | 24.43 | 35 | 403 | 281 | 24742 |
| ......s..[DE].... | CK II | 9.54 | 97 | 368 | 3409 | 24461 |
| ......s.[DE].... | CaMK | 6.63 | 60 | 271 | 2365 | 21052 |
| | II/G-CK | | | | | |

*Score = Σ-log(p)
**p < 10⁻⁶, occurrences ≧ 10.
***p < 10⁻⁶, occurrences ≧ 20.

The most significant motif identified, tPP (where lowercase letters indicate phosphorylated residues) appeared in 62 unique sequences from the dataset, representing approximately 32% of the phosphorylation data. The same motif was identified in only 0.7% of the background dataset, thereby highlighting the statistical significance of this motif.

To further visualize the identified motifs, sequences from the subset of the phosphorylation dataset containing the motifs were used to construct sequence logos in which the height of each residue in the logo was proportional to its frequency in the subset [Schneider, T. D. & Stephens, R. M. Sequence logos: a new way to display consensus sequences. Nucleic Acids Res 18, 6097-6100 (1990); Crooks, G. E., Hon, G., Chandonia, J. M. & Brenner, S. E. WebLogo: a sequence logo generator. Genome Res 14, 1188-1190 (2004)].

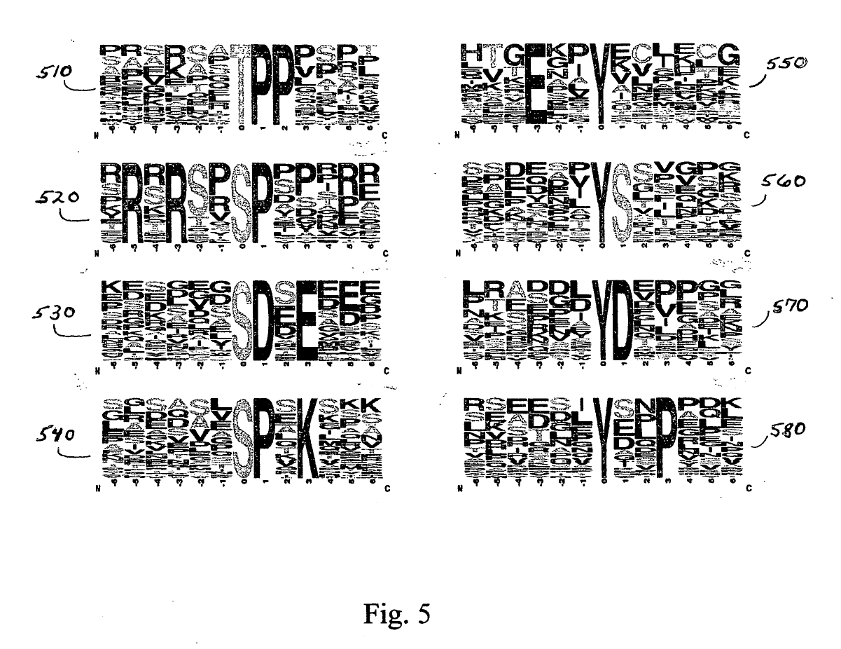

FIG. 5 presents sequence logo representations of various extracted motifs. The most significant motifs are from the threonine 510 and serine 520 phosphorylation datasets, respectively. It is evident from the sequence logo 510 for the tPP motif that a preference for basic residues exists at the −3 position of the motif. Further examples of significant motifs from the serine phosphorylation dataset are the extracted casein II kinase motif 530, the extracted cyclin dependent kinase motif 540, one of the NPM-ALK fusion kinase motifs showing a phosphorylated tyrosine residue in C₂H₂ zinc finger domain 550, a unique candidate c-Src motif 560, a candidate c-Src motif 570 similar to that found by combinatorial peptide library screening approaches, and a motif 580 similar to motif 570, extracted from pervanadate-treated Jurkat cell dataset consistent with known Src activation within these cells.

To address the issue of conservative amino acid substitutions, often found in kinase motifs, degenerate phosphorylation and background datasets were created wherein the 20 amino acids were condensed into an 11 amino acid code based on residue characteristics (shaded portion of Table 1). Not surprisingly, the degenerate analysis yielded a more specific analog of the initial motif, [RK]xxtPP (where “x” denotes any character and “t” represents the phosphorylated threonine), which was 168-fold overrepresented in the phosphorylation dataset as compared to the background. Sequences from the dataset which contained this phosphorylated motif indicated a significant number of transcription-related proteins including eIF4γ2, eIF3, HOMEZ, PPRB, TCF20, RUNX1, and DRPLA. Despite their overwhelming statistical significance in this dataset, it is interesting that the biological significance of these motifs has yet to be reported in the literature.

The motif analysis of serine phosphorylated peptides from the Beausoleil, Jedrychowski, et al. dataset indicated successful decomposition into 12 previously identified kinase motifs and 6 novel motifs (Table 1, second non-shaded region), which together were able to account for 85% of the starting phosphorylated dataset. A computational analysis of the sequence space of the 1594 phosphorylated peptides revealed an upper bound of 246,383 potential motifs (containing 1, 2, or 3 “locked” positions). Using the highly conservative assumptions that approximately 100 serine phosphorylation motifs exist in the literature and all are represented in the dataset, then the probability of extracting a single known motif by chance is 0.0004 (100/246,383) and the odds of extracting 12 known motifs is vanishingly small. Thus, the identification of 12 known motifs served both as a validation of the methodology, and a positive control for the data. Among these were motifs for MAPK, CDK, Casein II kinase, AKT, CaMK II, and G-CK (Table 1). Surprisingly however, the novel motifs RxRxxsP, RxxsPxP, and sPxxxRR were among the most significant motifs identified. Although they share similarities with both basophilic and proline-directed kinases, these motifs have not been previously characterized. Inspection of the proteins identified from the dataset containing these novel motifs revealed a disproportionate number of the so-called RS domain containing proteins involved in RNA binding and splicing [Boucher, L., Ouzounis, C. A., Enright, A. J. & Blencowe, B. J. A genome-wide survey of RS domain proteins. Rna 7, 1693-1701 (2001)].

While the ability of the motif building algorithm to decompose a large dataset into constitutive motifs has thus been demonstrated, the performance of the present invention on small datasets containing fewer motifs was also tested. The datasets from the Rush et al. tyrosine phosphorylation immunoaffinity-MS/MS study were employed for this test. The first of these datasets contained tyrosine phosphorylated peptides from two cell lines, Karpas 299 and SUD-DHL-1, both of which are known to express constitutively active NPM-ALK [Fujimoto, J. et al. Characterization of the transforming activity of p80, a hyperphosphorylated protein in a Ki-1 lymphoma cell line with chromosomal translocation t(2; 5). Proc Natl Acad Sci USA 93, 4181-4186 (1996)], an oncogenic fusion tyrosine kinase.

Table 2 presents the results of normal and degenerate analyses of NPM-ALK, c-Src and pervanadate-treated Jurkat cell phosphorylated tyrosine motifs from the Rush, et al. dataset. The degenerate motif building analysis was able to extract four novel motif classes (Table 2, first shaded region). These motifs represent candidate consensus sequences for NPM-ALK, a kinase which currently has no known consensus.

TABLE 2

| | | | | |
|---|---|---|---|---|
| | | | Phospho Dataset | Background Dataset |
| Motif | Literature | Score* | (Matches/Size) | (Matches/Size) |

NPM-ALK motifs**

| | | | | | | |
|---|---|---|---|---|---|---|
| ......y..v... | Novel | 16.00 | 47 | 237 | 24781 | 441343 |
| ...E..y...... | Novel | 8.90 | 34 | 180 | 24251 | 416562 |
| ......y[DE].[ILVM]... | Novel | 24.63 | 37 | 237 | 10533 | 441343 |
| ......y..[ILVM]... | Novel | 10.69 | 80 | 200 | 84036 | 430810 |
| ...[DE]..y...... | Novel | 7.35 | 34 | 120 | 36258 | 346774 |
| ......y....[FY]. | Novel | 6.22 | 22 | 86 | 24426 | 310516 |
| c-Src motifs** | | | | | | |
| ......yS..... | Novel | 8.58 | 40 | 185 | 34153 | 441343 |
| ......yD..... | Src | 7.75 | 26 | 145 | 20509 | 407190 |
| | consensus | | | | | |
| ...E..y...... | Src | 6.40 | 23 | 119 | 22643 | 386681 |
| | consensus | | | | | |
| ...[DE]..y...... | Src | 12.76 | 56 | 185 | 46522 | 441343 |
| | consensus | | | | | |
| ......y[DE]..... | Src | 7.37 | 34 | 129 | 38047 | 394821 |
| | consensus | | | | | |
| ......y[ST]..... | Novel | 6.00 | 33 | 95 | 52558 | 356774 |
| ......y[AG]..... | Src | 6.27 | 26 | 62 | 46997 | 304216 |
| | consensus | | | | | |
| Jurkat cell line motifs** | | | | | | |
| ......y..P... | Src | 8.75 | 29 | 151 | 23459 | 441343 |
| | consensus | | | | | |
| ...D..y...... | Src | 6.61 | 21 | 122 | 19539 | 417884 |
| | consensus | | | | | |
| ...E..y...... | Src | 6.75 | 22 | 101 | 24466 | 398345 |
| | consensus | | | | | |
| ...[DE]..y...... | Src | 15.65 | 54 | 151 | 46522 | 441343 |
| | consensus | | | | | |

*Score = Σ-log(p)
**p < 10⁻⁶, occurrences ≧ 10.

Inspection of the sequence logo for the Exxy NPM-ALK motif 550 in FIG. 5 indicated a clear C₂H₂ zinc finger domain consensus sequence, with the phosphorylation site falling between the second histidine (position −6) and first cysteine (position 2) of the domain [Iuchi, S. Three classes of C2H2 zinc finger proteins. Cell Mol Life Sci 58, 625-635 (2001)]. Interestingly, there are 14 unique phosphorylated C₂H₂ zinc fingers identified by the dataset, all of which contain an invariable glutamic acid at the −3 position despite the fact that this residue is not well conserved among all members of the C₂H₂ zinc finger family of proteins. Though not mentioned in the Rush et al. study, this represents the first example of tyrosine phosphorylation in a zinc finger domain. The possibility exists that this phosphorylation event interferes with zinc coordination and may shed light on the poorly understood process by which zinc fingers associate and dissociate from their cognate DNA sequences.

The next dataset analyzed from the Rush et al. study contained tyrosine phosphorylated sequences from cells expressing constitutively active c-Src kinase. The optimal substrate sequence for c-Src has been determined by combinatorial library screening methods to be DEEIy[GE]EFF [Songyang, Z. & Cantley, L. C. Recognition and specificity in protein tyrosine kinase-mediated signalling. Trends Biochem Sci 20, 470-475 (1995)]. Comparison of the consensus to the motifs identified in this study yielded some striking similarities and differences (Table 3). The sequence logo for the c-Src motif yD 570, despite containing only 26 unique sequences, shares similar residue characteristics at nearly all positions with the in vitro determined consensus, while the most significant motif identified, yS 560, bears only slight resemblance to the library-based c-Src motif.

The normal and degenerate motif analysis from the pervanadate-treated Jurkat cells in the third Rush et al. dataset also revealed several motifs, all of which are indicative of the known Src activation in these cells [Branch, D. R. & Mills, G. B. pp60c-src expression is induced by activation of normal human T lymphocytes. J Immunol 154, 3678-3685 (1995)]. One such significant motif 580 contained a proline at the +3 position (accounting for approximately one fifth of the dataset), consistent with recent work which has indicated the ability of Src kinase to also phosphorylate YxxP motifs [Shin, N. Y. et al. Subsets of the major tyrosine phosphorylation sites in Crk-associated substrate (CAS) are sufficient to promote cell migration. J Biol Chem 279, 38331-38337 (2004)].

The currently preferred embodiment of the present invention has been implemented as software. All programming was done using the PERL programming language on a linux workstation (2.2 GHz microprocessor with 1.5 GB RAM). Sequence logos were generated online using Weblogo [Schneider, T. D. & Stephens, R. M. Sequence logos: a new way to display consensus sequences. Nucleic Acids Res 18, 6097-6100 (1990)], available at http://weblogo.berkeley.edu/. Table 3 presents a Perl script that is the presently preferred implementation of the invention.

```
TABLE 3
#!/usr/bin/perl
#Dan Schwartz
#program motif-X.pl
use strict;
use lib qw!/home/dan/perllib /home/dan/perllib/i386-linux-thread-multi!;
use Math::CDF qw(:all);
$|=1;
my $phosresidue = $ARGV[0];
die (“Bad residue $phosresidue\n”) if($phosresidue !˜ /\hat{ }[A-Za-z]$/);
my $width = $ARGV[1];
my $sig = $ARGV[2];
my $MOTIFILE =‘dataset file name’;
open (MOTIFILE, “$MOTIFILE”) || die “can't open file
$MOTIFILE: $!”;
my $CONTROLFILE = ‘background file name’;
open (CONTROLFILE, “$CONTROLFILE”) || die “can't open
file $CONTROLFILE:
$!”;
my $OUTFILE = “output file name”;
open (OUTFILE, “>$OUTFILE”) || die “can't open output file $OUTFILE
for writing: $!”;
select OUTFILE; $|= 1;
my $motif;
foreach my $i (1..$width) {
  $motif .= ‘.’;
}
my @EPEPS = <MOTIFILE>;
my @MPEPS;
my %MPEPS;
foreach my $peptide (@EPEPS) {
  $peptide =˜ s/[\r\n]+//gs;
  my $pos = −1;
  while (($pos = index($peptide, $phosresidue, $pos)) > −1){
    if (($pos+6 <= length($peptide)−1) && ($pos−6 >= 0)) {
      my $newpeptide = substr($peptide,$pos−6,13);
      $MPEPS{$newpeptide}++;
    }
    $pos++;
  }
}
my @CPEPS = <CONTROLFILE>;
my $newmotif;
@MPEPS = keys %MPEPS;
do {
  my $score=0;
  ($newmotif, $score) = motifind(\@MPEPS,\@CPEPS,$motif,$score);
  my $tempmotif = $newmotif;
  substr($tempmotif,int($width/2),1) = $phosresidue;
  my $mlevel1 = divide(\@MPEPS,$newmotif,“level1”);
  @MPEPS = @$mlevel1;
  my $clevel1 = divide(\@CPEPS,$newmotif,“level1”);
  @CPEPS = @$clevel1;
} until ($newmotif eq $motif);
close (MOTIFILE);
close (CONTROLFILE);
close (OUTFILE);
sub motifind {
  my $mpeps = $_[0];
  my $cpeps = $_[1];
  my $consensus = $_[2];
  my $scoresum = $_[3];
  my $tempscore = $scoresum;
  my $newconsensus = $consensus;
  my ($clevel2,$mlevel2);
  my ($mpepfreq, $mtotal) = freqfind($mpeps,‘frequency’);
  my ($cpepperc, $ctotal) = freqfind($cpeps,‘percent’);
  my ($sigaapos,$found,$logscore) =
sigfind($mpepfreq,$cpepperc,$mtotal,$newconsensus);
  if ($found) {
    $tempscore = $scoresum + $logscore;
    $tempscore = sprintf(“%.2f”, $tempscore);
    my ($aa, $pos) = split /_/, $sigaapos;
    substr($newconsensus,$pos,1) = $aa;
    $mlevel2 = divide($mpeps,$newconsensus,“level2”);
    $clevel2 = divide($cpeps,$newconsensus,“level2”);
    if ((scalar(@$clevel2)<0) || (scalar(@$mlevel2)<20)){
      return ($consensus, $scoresum);
    }
    else {
      my $total1 = scalar(@$mlevel2);
      my $total2 = scalar(@$clevel2);
      my $total3 = scalar(@MPEPS);
      my $total4 = scalar(@CPEPS);
      my $finalmotif = $newconsensus;
      substr($finalmotif,int($width/2),1) = $phosresidue;
      print OUTFILE
“$finalmotif\t\t$tempscore\t$total1\t$total2\t$total3\t$total4\n”;
      print OUTFILE join(“\n”,@$mlevel2).“\n”;
      return motifind($mlevel2, $clevel2, $newconsensus, $tempscore);
    }
  }
  else {
    return ($consensus, $scoresum);
  }
}
sub divide {
  my $peps = $_[0];
  my @peps = @$peps;
  my $consensus = $_[1];
  $consensus =˜ s/\./\\w/g;
  my $level = $_[2];
  my @level1;
  my @level2;
  foreach my $pep (@peps) {
    $pep =˜ s/[\r\n]+//gs;
    if ($pep =˜ m/$consensus/i) {
      push (@level2, $pep);
    }
    else {
      push (@level1, $pep);
    }
  }
  if ($level eq “level1”) {
    return (\@level1);
  }
  if ($level eq “level2”){
    return (\@level2);
  }
}
sub sigfind {
  my $mpepfreq = $_[0];
  my $cpepperc = $_[1];
  my %mpepfreq = %$mpepfreq;
  my %cpepperc = %$cpepperc;
  my $trials = $_[2];
  my $consensus = $_[3];
  my $newconsensus = $consensus;
  $newconsensus =˜ sΛ./x/g;
  my $found=0;
  my $centpos = int($width/2);
  my %pbinom;
  my $pbinom;
  my $maxlog = 0;
  my $maxfreq = 0;
  my $sigaapos;
  my $ratio;
  my $ln10 = log(10);
  my $log = 0;
  foreach my $ap (keys %mpepfreq) {
    my ($aa, $pos) = split /_/,$ap;
    $ratio = $mpepfreq {$ap}/$trials;
    $pbinom = 1 − pbinom($mpepfreq {$ap}−1,$trials,$cpepperc
    {uc($ap)});
    unless ($pbinom == 0) {
      $log = abs(log($pbinom)/$ln10);
    }
    else {
      $log = 16;
    }
    if ((($pbinom < $sig) || ($ratio >= 0.85)) &&
(substr($consensus,$pos,1) ne $aa) && (($log > $maxlog) || (($log ==
$maxlog) && ($mpepfreq{$ap} > $maxfreq))) &&
!($ap =˜ m/$centpos/) &&
($mpepfreq{$ap} >= 20)){
      $sigaapos = $ap;
      $maxlog = $log;
      $maxfreq = $mpepfreq{$ap};
      $found=1;
    }
  }
  return ($sigaapos,$found,$maxlog);
}
sub freqfind {
  my $peps = $_[0];
  my $type = $_[1];
  my @peps = @$peps;
  my %pepfreq;
  my %pepperc;
  my $count;
  foreach my $pos (0..$width−1) {
    foreach my $pep (@peps){
      $count++;
      my $aa = substr($pep,$pos,1);
      my $aapos = “$aa\_$pos”;
      $pepfreq {$aapos}++;
    }
  }
  my $total = $count/$width;
  foreach my $ap (keys %pepfreq) {
    $pepperc{$ap} = $pepfreq{$ap}/$total;
  }
  if ($type eq ‘frequency’) {
    return (\%pepfreq,$total);
  }
  else {
    return (\%pepperc,$total);
  }
}
```

Although the present invention is used in the description and in the examples presented for the extraction of sequence motifs from a biological dataset, it can be used in a more general sense to extract correlated variables from any dataset, thus allowing for numerous applications. To test the effectiveness of the present invention, it was applied to a linguistic dataset and its ability to extract English language motifs was observed. In one example, the invention was applied to the first ten chapters of the classic English novel Moby Dick [Melville, H. Moby-Dick; or: The whale. (Harper & Brothers; Richard Bentley, New York, London; 1851)].

Using a framework previously conceptualized by Bussemaker et al. to test their algorithm for the detection of regulatory DNA motifs, the motif building strategy of the present invention was applied to the first ten chapters of the novel “Moby Dick” with random characters (at text frequencies) inserted between words [Bussemaker, H. J., Li, H. & Siggia, E. D. Building a dictionary for genomes: identification of presumptive regulatory sites by statistical analysis. Proc Natl Acad Sci USA 97, 10096-10100 (2000)]. The text was divided into overlapping blocks of 21 characters as the background matrix and 26 sequence dataset matrices were created, one centered on each letter. By taking a sliding 13 character window, the text was then transformed into a matrix of all 13 character strings, thus constituting the background dataset. From this background dataset, 26 subsets were created, each being centered on a different letter of the alphabet.

Using the background dataset and each of the subsets, the motif building methodology was carried out 26 times, thus yielding motifs centered on every letter of the alphabet. Using the criteria p<10⁻⁶ and occurrences≧10, 384 unique motifs were extracted, of which 371 mapped back to English words in the original text, indicating a false positive rate of 3.4%. Additionally, the motifs extracted covered 93.4% of the English words in the original text (3886 out of 4160). If the motifs were required to have at least two fixed letter/position pairs (aside from the central letter), a scenario more suitable for a large linguistic dataset, then 317 unique motifs were extracted with only one false positive (FP rate=0.32%) and a coverage of 67.1%. Table 4 presents the first motif extracted from each of the 26 Moby Dick subsets representing each letter of the alphabet.

TABLE 4

| | | Subset | | Background | |
|---|---|---|---|---|---|
| Motif | Score | Matches | Size | Matches | Size |

| | | | | | |
|---|---|---|---|---|---|
| ......and.... | 32.00 | 841 | 13886 | 1399 | 264242 |
| ......but.... | 32.00 | 203 | 8299 | 776 | 264242 |
| ......comp... | 47.00 | 35 | 8703 | 45 | 264242 |
| ....and...... | 32.00 | 841 | 10426 | 1718 | 264242 |
| ....ther..... | 47.65 | 278 | 17239 | 313 | 264242 |
| .....off..... | 29.97 | 79 | 8614 | 427 | 264242 |
| .e..ing...... | 44.99 | 174 | 8984 | 243 | 264242 |
| .....the..... | 32.00 | 1666 | 12463 | 2271 | 264242 |
| ......ing.... | 32.00 | 839 | 12711 | 1288 | 264242 |
| .....qj...... | 7.13 | 263 | 7058 | 7018 | 264242 |
| ..b.ack...... | 37.47 | 22 | 7430 | 31 | 264242 |
| .....all..... | 32.00 | 252 | 10907 | 769 | 264242 |
| ....some..... | 48.00 | 75 | 9076 | 117 | 264242 |
| .....ing..... | 32.00 | 838 | 13016 | 1107 | 264242 |
| ....p.one.... | 43.27 | 45 | 13300 | 60 | 264242 |
| .....upon.... | 45.95 | 64 | 8378 | 85 | 264242 |
| ......quee... | 43.16 | 34 | 7018 | 41 | 264242 |
| ....here..... | 48.00 | 193 | 11437 | 317 | 264242 |
| ......str..g. | 45.69 | 43 | 12581 | 51 | 264242 |
| ......the.... | 32.00 | 1665 | 14706 | 2549 | 264242 |
| ...about..... | 52.18 | 51 | 9178 | 55 | 264242 |
| .....ever.... | 48.00 | 103 | 7470 | 174 | 264242 |
| ......was.... | 32.00 | 204 | 8976 | 955 | 264242 |
| .....xx...... | 6.76 | 256 | 6965 | 6965 | 264242 |
| ...only...... | 42.34 | 33 | 8396 | 51 | 264242 |
| ......zz..... | 6.75 | 259 | 7014 | 7014 | 264242 |

It is important to note that since approximately half of the data in this analysis was composed of random characters, the false positive rate was substantially higher than would be expected in the phosphorylation dataset analysis where all of the data was centered on true phosphorylation sites. Nevertheless, to remain conservative, these same stringent p-value and occurrence thresholds were retained in biological analyses.

As proteomic sequence datasets grow ever larger, tools for the extraction of biologically relevant motifs will become even more useful. The present invention represents the first attempt to extract biologically relevant motifs based on sequence information from large-scale mass spectrometry-based datasets, and is meant to serve as a starting point for future research. Using a statistical framework which does not assume independence of positions in the motif due to a dynamic statistical background, a two step methodology of motif building and set reduction is employed to decompose a given dataset into its constitutive motifs. The present invention's usefulness has been exemplified through its ability to extract known and novel motifs from several phosphorylation datasets. Since the motifs and their cognate position weight matrices are generated from actual in vivo phosphorylation sites as opposed to synthetic peptide libraries, the method may lead to an improvement in phospho-site prediction. Given the success of the present invention when applied to a linguistic dataset, it is apparent that the method has the versatility to extract motifs from a wide range of datasets including, but not limited to, other post-translational modifications and genomic data. Additionally, the present invention may lead to the discovery of novel biologically relevant protein motifs directly from a raw proteome.

The present invention, therefore, provides a tool for the efficient extraction of motifs from sequence data. It builds significant motifs from smaller motifs, determines their significance based on a dynamic background, can extract multiple motifs from the same dataset, and does not assume independence of positions in the motif. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A method for the extraction of motifs from a dataset containing sequence data, comprising the steps of:
selecting an initial core character;
justifying the sequence data around the selected core character;
creating a sequence dataset matrix from the justified sequence data;
creating a background dataset matrix;
calculating the binomial probability of each possible character in every column of the sequence dataset matrix using the sequence dataset and background dataset matrices;
comparing the binomial probabilities to a specified threshold;
if at least one binomial probability is below the threshold:
selecting the character-column pair having the lowest binomial probability under the threshold;
extracting those sequences in the sequence and background dataset matrices that contain the selected character-column pair;
placing the extracted sequences into new sequence and background dataset matrices; and
calculating the binomial probability of each character in every column of the new sequence dataset matrix; and
if no character-column pair has a binomial probability below the specified threshold, but at least one significant character-column pair has been identified during the current cycle:
identifying the present motif;
removing all sequences containing the identified motif from the current initial sequence and background dataset matrices; and
calculating the binomial probability of each character in every column of the new initial sequence dataset matrix using the new initial background dataset matrix.

2. The method of claim 1, further including the step of:
if no significant character-column pair has been identified during the current cycle, but there are additional characters available to be used as the core character:
selecting a new core character; and
repeating the cycle.

3. The method of claim 1, wherein the dataset is a biological dataset.

4. The method of claim 3, wherein the core character is a core residue.

5. The method of claim 4, wherein the core residue is phosphorylated.

6. The method of claim 2, wherein the dataset is a biological dataset.

7. The method of claim 6, wherein the core character is a core residue.

8. The method of claim 7, wherein the core residue is phosphorylated.

9. A tool for the extraction of motifs from a dataset, comprising:
a core character selector;
a data justification function that justifies sequence data from the dataset around the selected core character;
a matrix creation function that creates at least one sequence dataset matrices from the justified sequence data, at least one background dataset matrix, and new sequence dataset and background dataset matrices after extraction of at least one data sequence from the sequence dataset and background dataset matrices;
a binomial probability calculation function that calculates the binomial probability of each possible character in every column of the sequence dataset matrix using the sequence dataset and background dataset matrices;
a binomial probability comparator that compares calculated binomial probabilities with a defined threshold;
a binomial probability selector that selects a character-column pair having the lowest binomial probability that is under the defined threshold;
a data sequence extractor that extracts those sequences in the sequence and background dataset matrices that contain a selected character-column pair; and
a motif identifier that identifies a current motif when no character-column pair has a calculated binomial probability below the defined threshold.

10. A computer-readable medium, the medium being characterized in that:
the computer-readable medium contains code which, when executed in a processor, performs the steps of:
selecting an initial core character;
justifying the sequence data around the selected core character;
creating a sequence dataset matrix from the justified sequence data;
creating a background dataset matrix;
calculating the binomial probability of each possible character in every column of the sequence dataset matrix using the sequence dataset and background dataset matrices;
comparing the binomial probabilities to a specified threshold;
if at least one binomial probability is below the threshold:
selecting the character-column pair having the lowest binomial probability under the threshold;
extracting those sequences in the sequence and background dataset matrices that contain the selected character-column pair;
placing the extracted sequences into new sequence and background dataset matrices; and
calculating the binomial probability of each character in every column of the new sequence dataset matrix; and
if no character-column pair has a binomial probability below the specified threshold, but at least one significant character-column pair has been identified during the current cycle:
identifying the present motif;
removing all sequences containing the identified motif from the current initial sequence and background dataset matrices; and
calculating the binomial probability of each character in every column of the new initial sequence dataset matrix using the new initial background dataset matrix.

11. The computer-readable medium of claim 10, the medium further being characterized in that:
the computer-readable medium contains code which, when executed in a processor, performs the step of:
if no significant character-column pair has been identified during the current cycle, but there are additional characters available to be used as the core character:
selecting a new core character; and
repeating the cycle.

12. The computer-readable medium of claim 10, wherein the dataset is a biological dataset.

13. The computer-readable medium of claim 12, wherein the core character is a core residue.

14. The computer-readable medium of claim 13, wherein the core residue is phosphorylated.

15. The computer-readable medium of claim 11, wherein the dataset is a biological dataset.

16. The computer-readable medium of claim 15, wherein the core character is a core residue.

17. The computer-readable medium of claim 16, wherein the core residue is phosphorylated.
